(19) United States
(12) Patent Application Publication
(10) Pub. No.: US 2015/0146705 A1
(43) Pub. Date: May 28, 2015

(54) ELECTRONIC DEVICE AND METHOD FOR PROVIDING DATA SERVICE IN ELECTRONIC DEVICE

(71) Applicant: Samsung Electronics Co., Ltd., Gyeonggi-do (KR)

(72) Inventors: Jeong-Il KWON, Seoul (KR); Bu-Seop Jung, Gyeonggi-do (KR); Jung-Hun Lee, Gyeonggi-do (KR)

(73) Assignee: Samsung Electronics Co., Ltd.

(21) Appl. No.: 14/473,428

(22) Filed: Aug. 29, 2014

(30) Foreign Application Priority Data
Nov. 26, 2013 (KR) 10-2013-0144496

(51) Int. Cl. H04W 48/16; H04W 4/00; H04W 52/02; H04W 88/04

(52) U.S. Cl. CPC H04W 48/16; H04W 88/04; H04W 4/008; H04W 52/0277
USPC 370/338

(57) ABSTRACT

An electronic device and a method for providing a data service in the electronic device are provided. The electronic device includes a short-range wireless communication unit configured to provide a short-range wireless communication function, and a controller configured, if the electronic device is connected to another electronic device upon activation of an Access Point (AP) function, to detect an AP connectable to the other electronic device, and if an AP connectable to the other electronic device is detected, to deactivate the AP function.

### PRIORITY

This application claims priority under 35 U.S.C. §119(a) to a Korean Patent Application filed in the Korean Intellectual Property Office on Nov. 26, 2013 and assigned Serial No. 10-2013-0144496, the entire disclosure of which is incorporated herein by reference.

### BACKGROUND

1. Field of the Invention

The present invention generally relates to an electronic device and a method for providing a data service in the electronic device, and more particularly, to an electronic device for providing a data service, while reducing current consumption and a method for providing a data service in the electronic device.

2. Description of the Related Art

Recently, tethering over Wi-Fi has become an issue. Tethering is a service of enabling a terminal to which a network is inaccessible to access the network and use an Internet service using a Wi-Fi terminal having Long Term Evolution (LIE), 3^{rd} Generation (3G), or 2^{nd} Generation (2G) connectivity as a Wi-Fi hot spot.

So far, tethering has been implemented using Wi-Fi ad-hoc technology. An ad-hoc network supports limited security modes and suffers from unstable connections, thereby making it difficult to provide a stable ad-hoc data connection.

Moreover, the ad-hoc tethering limits the number of connected client terminals to one or two and the connected client terminals have difficulty in saving power.

In this context, an Access Point (AP) function is added to recent Wi-Fi terminals so that tethering is enabled in an infrastructure mode using an AP, not in an ad-hoc-based manner, as is the case with an AP-based Internet connection.

If a terminal supporting both mobile data and Wi-Fi is equipped with the Wi-Fi tethering function, a Wi-Fi only terminal may receive an Internet service at any time in any place in an environment where mobile data is available.

If a user turns on tethering in a terminal supporting Wi-Fi tethering, the Wi-Fi tethering function is activated. Only when the user turns off tethering or the battery power of the terminal is low, is the Wi-Fi tethering function deactivated.

When the Wi-Fi tethering function is active, the terminal serves as a Wi-Fi AP. Since the AP is always awake managing client terminals, the AP does not support a sleep mode. As a consequence, if the Wi-Fi tethering function is activated in the terminal, the terminal consumes a standby current of 60 to 70 mA at minimum.

This current consumption is ten times larger than consumption of a standby current of 5 to 7 ms during activation of a general Wi-Fi function. As a result, the life time of the battery of the terminal is shortened.

### SUMMARY

An aspect of the present invention is to address at least the above-mentioned problems and/or disadvantages and to provide at least the advantages described below. Accordingly, an aspect of the present invention is to provide an electronic device for reducing current consumption, while providing a data service, and a method for providing a data service in the electronic device.

In accordance with an aspect of the present invention, an electronic device is provided. The electronic device includes a short-range wireless communication unit configured to provide a short-range wireless communication function, and a controller configured, if the electronic device is connected to another electronic device upon activation of an Access Point (AP) function, to detect an AP connectable to the other electronic device, and if an AP connectable to the other electronic device is detected, to deactivate the AP function.

In accordance with another aspect of the present invention, a method for providing a data service in an electronic device is provided. The method includes, if the electronic device is connected to another electronic device upon activation of an AP function, detecting an AP connectable to the other electronic device by scanning, and if an AP connectable to the other electronic device is detected, deactivating the AP function.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram of an electronic device according to various embodiments of the present invention;

FIG. 2 is a flowchart illustrating an operation for providing a data service in an electronic device according to an embodiment of the present invention;

FIG. 3 is a flowchart illustrating an operation for providing a data service in an electronic device according to another embodiment of the present invention;

FIG. 4 is a flowchart illustrating an operation for providing a data service in an electronic device according to another embodiment of the present invention;

FIG. 5 is a flowchart illustrating an operation for providing a data service in an electronic device according to another embodiment of the present invention; and

FIG. 6 is a flowchart illustrating an operation for providing a data service in an electronic device according to another embodiment of the present invention.

Throughout the drawings, like reference numerals will be understood to refer to like parts, components, and structures.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded as mere examples. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An electronic device according to various embodiments of the present invention may be a device with communication capabilities. For example, the electronic device may be one or a combination of two or more of various devices such as smart phone, tablet Personal Computer (PC), mobile phone, video phone, e-book reader, desktop PC, laptop PC, netbook computer, Personal Digital Assistant (PDA), Portable Multimedia Player (PMP), MP3 player, mobile medical equipment, electronic bracelet, electronic necklace, electronic accessory, camera, wearable device, electronic clock, wrist watch, home appliance (e.g., refrigerator, air conditioner, cleaner, oven, microwave, washer, air cleaner, and the like), Artificial Intelligence (AI) robot, Television (TV), Digital Versatile Disk (DVD) player, audio player, various medical devices (e.g., Magnetic Resonance Angiography (MRA), Magnetic Resonance Imaging (MRI), Computed Tomography (CT), medical camcorder, ultrasonic equipment, and the like), navigator, Global Positioning System (GPS) receiver, Event Data Recorder (EDR), Flight Data Recorder (FDR), set-top box, TV box (e.g., Samsung HomeSync™, Apple TV™, Google TV™, or the like), electronic dictionary, automotive infotainment device, electronic equipment for a ship (e.g., marine navigation device, gyro compass, and the like), avionics, security equipment, electronic apparel, electronic key, camcorder, game console, Head-Mounted Display (HMD), flat panel display device, electronic picture frame, electronic album, furniture or part of building/structure with communication capabilities, electronic board, electronic signature receiving device, wearable device, projector, and the like. It will be apparent to those of ordinary skill in the art that the electronic device according to various embodiments of the present invention is not limited to the aforementioned devices.

In various embodiments of the present invention, a first Access Point (AP) and a second AP operate in conformance with different connection schemes. For example, the first AP may be a non-Hotspot 2.0 AP that is not connected to an information server and the second AP may be a Hotspot 2.0 AP that is connected to an information server.

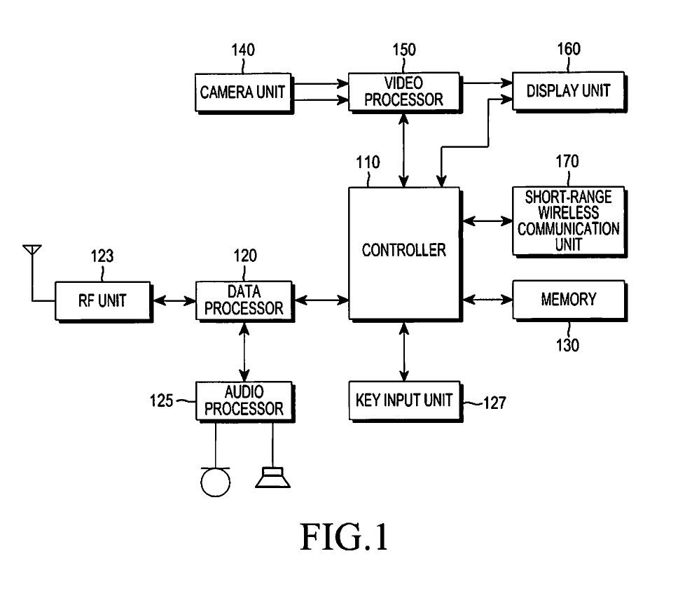

FIG. 1 is a block diagram of an electronic device according to various embodiments of the present invention.

Referring to FIG. 1, a Radio Frequency (RF) unit 123 is responsible for wireless communication of the electronic device. The RF unit 123 includes an RF transmitter for upconverting the frequency of a transmission signal and amplifying the upconverted transmission signal, and an RF receiver for low-noise-amplifying a received signal and downconverting the frequency of the low-noise-amplified received signal.

A data processor 120 includes a transmitter for encoding and modulating the transmission signal, and a receiver for demodulating and decoding the received signal. Thus, the data processor 120 may include a Modulator/Demodulator (MODEM) and a Coder/Decoder (CODEC). The CODEC may include a data CODEC for processing packet data and the like, and an audio CODEC for processing an audio signal such as voice.

An audio processor 125 plays an audio signal received from the audio CODEC in the data processor 120, through a Speaker (SPK), or transmits a transmission audio signal picked up by a Microphone (MIC) to the audio CODEC in the data processor 120.

A key input unit 127 includes alphanumerical keys for entering numeric/character information, and function keys for setting various functions.

A memory 130 may include a program memory and a data memory. The program memory stores programs for controlling the overall operations of the electronic device, and control programs for controlling the providing of a data service using an activated AP function, while reducing current consumption in the electronic device according to various embodiments of the present invention. The data memory may temporarily store data generated during execution of the programs.

In various embodiments of the present invention, the memory 130 may store at least one of an AP list and authentication information received from another electronic device which upon activation of the AP function in the electronic device, has been connected to the electronic device. The AP list includes information about at least one first AP that has been connected before to the other electronic device, and the authentication information is used for automatic connection of the other electronic device to a second AP operating in a different connection scheme from the first AP. The AP list may also include information about the position of the at least one first AP as well as the information about the at least one first AP.

A controller 110 controls the overall operation of the electronic device.

In various embodiments of the present invention, when tethering is turned on in the electronic device, the AP function of the electronic device is activated. Then the controller 110 connects the electronic device to another electronic device through a short-range wireless communication unit 170. When the electronic device is connected to the other electronic device, the controller 110 searches for an AP connectable to the other electronic device by scanning. Once an AP connectable to the other electronic device is detected, the controller 110 releases the connection from the other electronic device by deactivating the AP function so that the other electronic device may be connected to the detected AP.

When the electronic device is connected to the other electronic device upon activation of the AP function, the controller 110 receives, from the other electronic device, at least one of an AP list including information about at least one first AP that has been connected before to the other electronic device, and authentication information used for automatic connection of the other electronic device to a second AP operating in a different connection scheme from the first AP.

Alternatively, upon activation of the AP function, the controller 110 may connect the electronic device to another electronic device and transmit, to the other electronic device, identification information indicating that the other electronic device has been connected to the electronic device. Then the controller 110 may receive, from the other electronic device, at least one of an AP list including information about at least one first AP that has been connected before to the other electronic device, and authentication information used for automatic connection of the other electronic device to a second AP operating in a different connection scheme from the first AP.

The controller 110 searches for an AP connectable to the other electronic device by scanning based on at least one of the AP list including information about at least one first AP that has been connected before to the other electronic device, and the authentication information used for automatic connection of the other electronic device to a second AP operating in a different connection scheme from the first AP.

Upon deactivation of the AP function, the controller 110 scans by activating a short-range wireless communication function, for example, a Wi-Fi function and continuously searches for a first AP connectable to the other electronic device. If a first AP connectable to the other electronic device is not detected, the controller 110 may reconnect the electronic device to the other electronic device by activating the AP function and thus provide a data service to the other electronic device. The controller 110 keeps searching for an AP connectable to the other electronic device by scanning based on at least one of the AP list and the authentication information received previously from the other electronic device.

In various embodiments of the present invention, when the electronic device is connected to another electronic device upon activation of the AP function in the electronic device, the controller 110 receives, from the other electronic device, an AP list including information about at least one first AP that has been connected before to the other electronic device. Upon detection of a first AP included in the AP list by scanning, the controller 110 releases the connection from the other electronic device by deactivating the AP function. Upon deactivation of the AP function, the controller 110 scans by activating the short-range wireless communication function, for example, the Wi-Fi function and searches for a first AP included in the AP list by the scanning. If a first AP included in the AP list is not detected, the controller 110 reconnects the electronic device to the other electronic device by activating the AP function and thus provides a data service to the other electronic device.

In various embodiments of the present invention, when the electronic device is connected to another electronic device upon activation of the AP function in the electronic device, the controller 110 receives, from the other electronic device, an AP list including information about at least one first AP that has been connected before to the other electronic device. If the battery amount of the electronic device becomes less than equal to a threshold while the electronic device is connected to the other electronic device, the controller 110 searches for a first AP included in the AP list by scanning. Upon detection of a first AP included in the AP list by scanning, the controller 110 releases the connection from the other electronic device by deactivating the AP function. If a first AP included in the AP list by scanning is not detected, the controller 110 transmits connection release information to the other electronic device and releases the connection from the other electronic device by deactivating the AP function.

In various embodiments of the present invention, when the electronic device is connected to another electronic device upon activation of the AP function in the electronic device, the controller 110 receives, from the other electronic device, an AP list including information about at least one first AP that has been connected before to the other electronic device, and authentication information for automatic connection of the other electronic device to a second AP operating in a different connection scheme from the first AP. Upon detection of a first AP or a second AP by scanning, the controller 110 releases the connection from the other electronic device by deactivating the AP function.

Upon deactivation of the AP function, the controller 110 scans by activating the short-range wireless communication function, for example, the Wi-Fi function. The controller 110 keeps searching for a first AP included in the AP list or a second AP connectable to the other electronic device based on the authentication information by the scanning. If a first AP or a second AP is not detected, the controller 110 reconnects the electronic device to the other electronic device by activating the AP function, and thus provides a data service to the other electronic device.

In various embodiments of the present invention, the second AP supports Hotspot 2.0. Hotspot 2.0 is a new standard developed by the Wi-Fi Alliance (WFA), which enables a Wi-Fi electronic device to readily access a Public Wi-Fi network without any particular user input. To automatically access a Hotspot 2.0 network, the electronic device performs network discovery regarding a current Wi-Fi network by Access Network Query Protocol (ANQP) query/response and automatically accesses a network that matches authentication information (i.e., credentials) pre-stored in the electronic device. For example, a user using an SKT Subscriber Identity Module (SIM) may automatically access a Wi-Fi network provided by an operator such as SKT by a method such as Extensible Authentication Protocol-Subscriber Identity Module (EAP-SIM)/Authentication and Key Agreement (AKA).

In various embodiments of the present invention, authentication information used for automatic connection of another electronic device to a second AP, received at the controller 110 from the other electronic device may be a credential pre-stored in the other electronic device, for automatic connection to a Hotspot 2.0 network.

Once the controller 110 detects a second AP by scanning, the controller 110 receives authentication information from an information server connected to the detected second AP. The controller 110 compares the authentication information received from the information server with the authentication information for automatic connection of the other electronic device to the second AP, received from the other electronic device. If the two pieces of authentication information match, the controller 110 confirms the presence of the second AP connectable to the other electronic device.

In various embodiments of the present invention, if the electronic device is connected to another electronic device upon activation of the AP function, the controller 110 receives, from the other electronic device, an AP list including information about at least one first AP that has been connected before to the other electronic device, and authentication information for automatic connection of the other electronic device to a second AP operating in a different connection scheme from the first AP. While the electronic device is connected to the other electronic device, if the battery amount of the electronic device becomes less than or equal to a threshold in the electronic device, the controller 110 searches for a first AP included in the AP list or a second AP connectable to the other electronic device based on the authentication information. If the controller 110 detects a first AP or a second AP, the controller 110 releases the connection from the other electronic device by deactivating the AP function.

On the other hand, if the controller 110 fails to detect a first AP or a second AP, the controller 110 transmits connection release information to the other electronic device and deactivates the AP function, thus releasing the connection from the other electronic device.

In various embodiments of the present invention, if the electronic device is connected to another electronic device upon activation of the AP function, the controller 110 receives an AP list from the other electronic device. The AP list includes information about at least one first AP that has been connected before to the other electronic device, and information about the position of the at least one first AP. While the electronic device is connected to the other electronic device, if the battery amount of the electronic device becomes less than or equal to a threshold, the controller 110 searches for a first AP included in the AP list by scanning. If the controller 110 fails to detect any first AP, the controller 110 transmits connection release information along with information about a first AP closest to a current position of the electronic device to the other electronic device, and deactivates the AP function, thus releasing the connection from the other electronic device.

The short-range wireless communication unit 170 provides short-range wireless communication. The short-range communication may include Wi-Fi, Wireless broadband (Wibro), or mobile Worldwide interoperability for Microwave Access (WiMAX), or the like. For example, the short-range wireless communication unit 170 may provide a short-range wireless communication function to a user by connecting the user to an AP in conformance with the Institute of Electrical and Electronics Engineers (IEEE) 802.11 standard. In various embodiments of the present invention, the short-range wireless communication module 170 may support Hotspot 2.0 in conformance with the IEEE 802.11u specification.

A camera unit 140 includes a camera sensor that captures image data and converts a captured optical signal to an electrical signal, and a signal processor that converts an analog video signal captured by the camera sensor to digital data. It is assumed that the camera sensor is a Charge Coupled Device (CCD) sensor or a Complementary Metal Oxide Semiconductor (CMOS) sensor. The signal sensor may be configured as a Digital Signal Processor (DSP). The camera sensor and the signal processor may be incorporated into a single device or may be configured separately.

A video processor 150 performs Image Signal Processing (ISP) to display an image signal received from the camera unit 140 on a display 160. The ISP includes image processing functions such as gamma correction, interpolation, spatial change, image effect, image scaling, Automatic White Balance (AWB), Automatic Exposure (AE), Automatic Focus (AF), and the like. The video processor 150 processes an image signal received from the camera unit 140 on a frame-by-frame basis and outputs the image frame data according to the characteristics and size of the display 160. The video processor 150 includes a video CODEC to compress image frame data to be displayed on the display 160 in a predetermined method and recovers (or decompresses) compressed image frame data to original image frame data. The video CODEC may be a Joint Photographic Experts Group (JPEG) CODEC, a Moving Picture Experts Group 4 (MPEG4) CODEC, a Wavelet CODEC, or the like. The video processor 150 is assumed to have an On Screen Display (OSD) function, and outputs OSD data according to the size of a displayed screen under control of the controller 110.

The display 160 displays an image signal received from the video processor 150 on a screen, and displays user data received from the controller 110. The display 160 may be configured with a Liquid Crystal Display (LCD). In this case, the display 160 includes an LCD controller, a memory that stores video data, and an LCD device. If the LCD is configured as a touch screen, the LCD may serve as an input unit. In this case, virtual keys as would be on the key input unit 127 are displayed on the display 160.

If the display unit 160 is used as a touch screen unit and implemented in a touch screen manner, the touch screen unit may include a Touch Screen Panel (TSP) with a plurality of sensor panels. The sensor panels may include a capacitive sensor panel that senses a coarse touch by fingertips, and an electromagnetic induction sensor panel that senses a fine touch such as a touch of a touch pen.

While it has been described that the electronic device illustrated in FIG. 1 provides a data service to another electronic device by activating its AP function, the electronic device may receive a data service from another electronic device through activation of an AP function of the other electronic device.

In the case where the electronic device receives the data service from the other electronic device, when the electronic device is connected to the other electronic device, the electronic device transmits, to the other electronic device, at least one of an AP list including information about at least one first AP that has been connected before to the electronic device, and authentication information used for automatic connection of the electronic device to a second AP operating in a different connection scheme from the first AP.

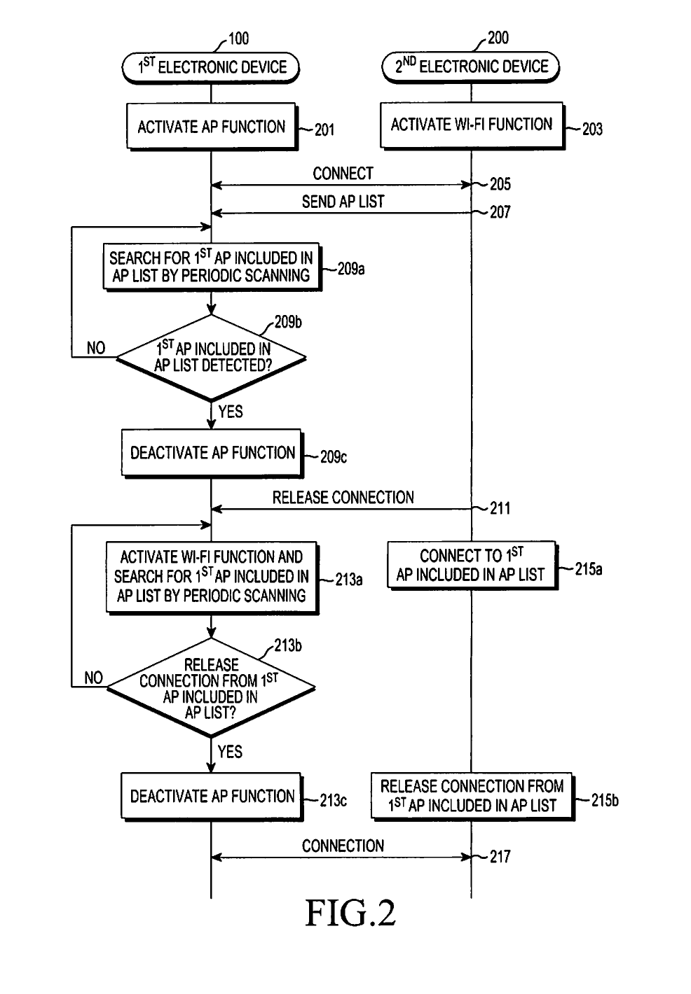

Operations for providing a data service in an electronic device will be described in detail with reference to FIGS. 2 to 6. In various embodiments of the present invention, a first electronic device and its components may have the configurations illustrated in FIG. 1.

FIG. 2 is a flowchart illustrating an operation for providing a data service in an electronic device according to an embodiment of the present invention. This embodiment of the present invention will be described in detail with reference to FIGS. 1 and 2.

Referring to FIG. 2, if a user turns on tethering in the first electronic device 100, a controller of the first electronic device 100 (hereinafter, referred to as a first controller) activates an AP function so that the first electronic device 100 serves as a Wi-Fi AP in step 201.

Before or after the activation of the AP function in the first electronic device 100, if a user turns on a short-range wireless communication function, for example, a Wi-Fi function, and thus the W-FI function is activated in a second electronic device 200, a controller of the second electronic device 200 (hereinafter, referred to as a second controller) detects the first electronic device 100 with the AP function activated and displays the first electronic device 100 as a connectable first AP on a display of the second electronic device 200 in step 203.

If the user of the second electronic device 200 selects the first electronic device 100 as a first AP and enters, for example, a password for authentication, the first and second electronic devices 100 and 200 connect to each other in step 205. Once the second electronic device 200 is connected to the first electronic device 100, the second controller transmits, to the first electronic device 100, an AP list including information about at least one first AP that has been connected before to the second electronic device 200, stored in the second electronic device, in step 207. Then the second controller may use a data service provided by the connected first electronic device 100.

Alternatively, after the first and second electronic devices 100 and 200 are connected to each other, the first controller may transmit identification information indicating the first electronic device 100, for example, a phone number, to the second electronic device 200. When the second controller determines that the connected first AP is the first electronic device 100 based on the identification information received from the first electronic device 100, the second controller transmits the AP list to the first electronic device 100. In an embodiment of the present invention, the AP list may be transmitted to the first electronic device 100 by a Wireless Local Area Network (WLAN) action frame or a data frame.

In step 209a, upon receipt of the AP list from the second electronic device 200, the first controller searches for at least one first AP included in the AP list by periodic background scanning.

Upon detection of a first AP included in the AP list by the scanning in step 209b, the first controller deactivates the AP function in step 209c, and thus releases the connection from the second electronic device 200 in step 211. If the first AP is not included in the AP list in step 209b, the controller returns to step 209a.

A condition for deactivating the AP function in step 209c may be set. For example, if the position of the first electronic device 100 is not changed and a first AP included in the AP list is detected a predetermined number of times or more (e.g., three or more times) for a predetermined time period, the AP function is deactivated. Alternatively, if the position of the first electronic device 100 is changed and a first AP included in the AP list is detected a predetermined number of times or more (e.g., three or more times) for a predetermined time period, the AP function is deactivated.

After the connection release from the second electronic device 200, the first controller performs periodic scanning by activating a short-range wireless communication function, for example, a Wi-Fi function and thus keeps searching for a nearby first AP included in the AP list in step 213a.

If the first controller detects a first AP included in the AP list by the periodic scanning in step 213b, the first controller deactivates the AP function in step 213c.

Meanwhile, if the second controller discovers a first AP included in the AP list by scanning after the connection release from the first electronic device 100, the second controller automatically connects the second electronic device 200 to the detected first AP in step 215a. If the first AP releases the connection during the data service in progress in step 215b, the second controller automatically connects the second electronic device 200 to the first electronic device 100 with the AP function activated by scanning in step 217. Since the first electronic device 100 is included as a first AP in the AP list of the second electronic device 200, if the second controller detects the first electronic device 100 by scanning, the second electronic device 200 may be connected automatically to the first electronic device 100.

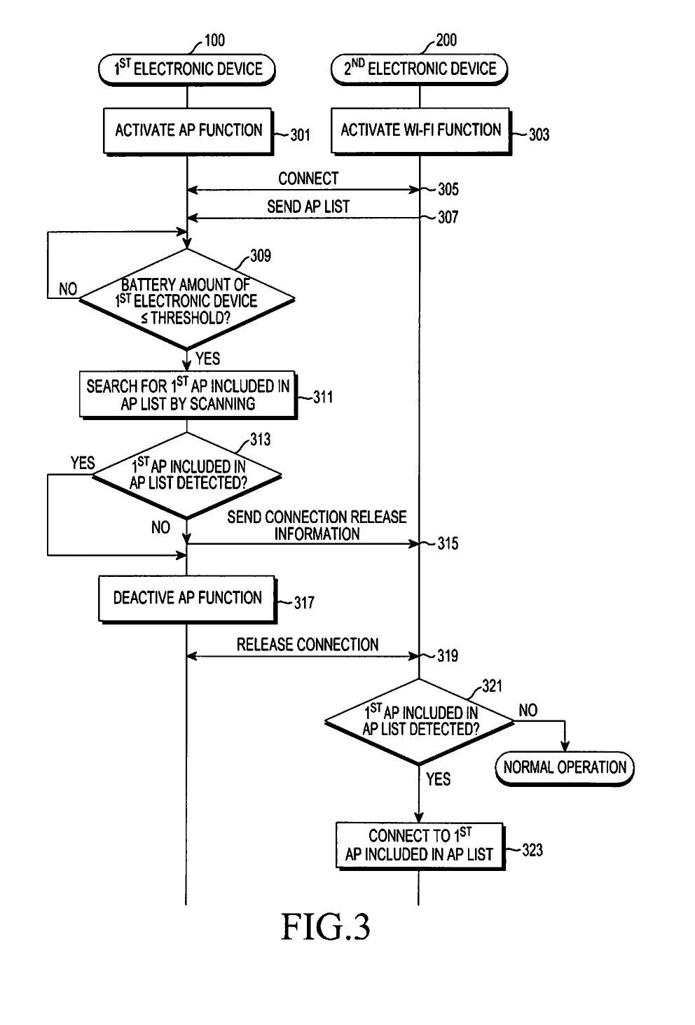

FIG. 3 is a flowchart illustrating an operation for providing a data service in an electronic device according to another embodiment of the present invention. This embodiment of the present invention will be described in detail with reference to FIGS. 1 and 3.

Referring to FIG. 3, if the user turns on tethering in the first electronic device 100, the controller of the first electronic device 100 (i.e., the first controller) activates the AP function so that the first electronic device 100 may serve as a Wi-Fi AP in step 301.

Before or after the activation of the AP function in the first electronic device 100, if the user turns on the short-range wireless communication function, for example, the Wi-Fi function, and thus the W-FI function is activated in the second electronic device 200, the controller of the second electronic device 200 (i.e., the second controller) detects the first electronic device 100 with the AP function activated and displays the first electronic device 100 as a connectable first AP on the display of the second electronic device 200 in step 303.

If the user of the second electronic device 200 selects the first electronic device 100 as a first AP and enters, for example, a password for authentication, the first and second electronic devices 100 and 200 connect to each other in step 305.

Once the second electronic device 200 is connected to the first electronic device 100, the second controller transmits, to the first electronic device 100, an AP list including information about at least one first AP that has been connected before to the second electronic device 200, stored in the second electronic device, in step 307. Then the second controller may use a data service provided by the connected first electronic device 100.

Alternatively, after the first and second electronic devices 100 and 200 are connected to each other, the first controller may transmit identification information indicating the first electronic device 100, for example, a phone number, to the second electronic device 200. When the second controller determines that the connected AP is the first electronic device 100 based on the identification information received from the first electronic device 100, the second controller transmits the AP list to the first electronic device 100.

In another embodiment of the present invention, the AP list may be transmitted to the first electronic device 100 by a WLAN action frame or a data frame.

In step 309, while the first electronic device 100 is connected to the second electronic device 200, the first controller compares a battery amount of the first electronic device 100 with a predetermined threshold.

If the battery amount of the first electronic device 100 is less than or equal to the threshold in step 309, the first controller searches for at least one first AP included in the AP list by scanning in step 311. If the battery amount is greater than the threshold, the first controller maintains step 309.

If the first controller fails to detect a first AP included in the AP list by the scanning in step 313, the first controller transmits information indicating connection release caused by battery shortage to the second electronic device 200 in step 315. Upon receipt of the information indicating connection release caused by battery shortage from the first electronic device 100, the second controller may display a message that the connection will be released due to battery shortage on the display of the second electronic device 200.

After transmitting the information indicating connection release caused by battery shortage to the second electronic device 200, the first controller deactivates the AP function in step 317, and thus releases the connection from the second electronic device 200 in step 319.

On the other hand, if the first controller detects a first AP included in the AP list by the scanning in step 313, the first controller deactivates the AP function in step 317, and thus releases the connection from the second electronic device 200 in step 319.

After the connection release from the first electronic device 100, the second controller searches for a first AP included in the AP list by scanning in step 321. If the second controller detects a first AP included in the AP list by the scanning in step 321, the second controller automatically connects the second electronic device 200 to the detected first AP in operation 323. If the second controller does not detect the first AP in the AP list in step 321, the second controller performs a normal operation.

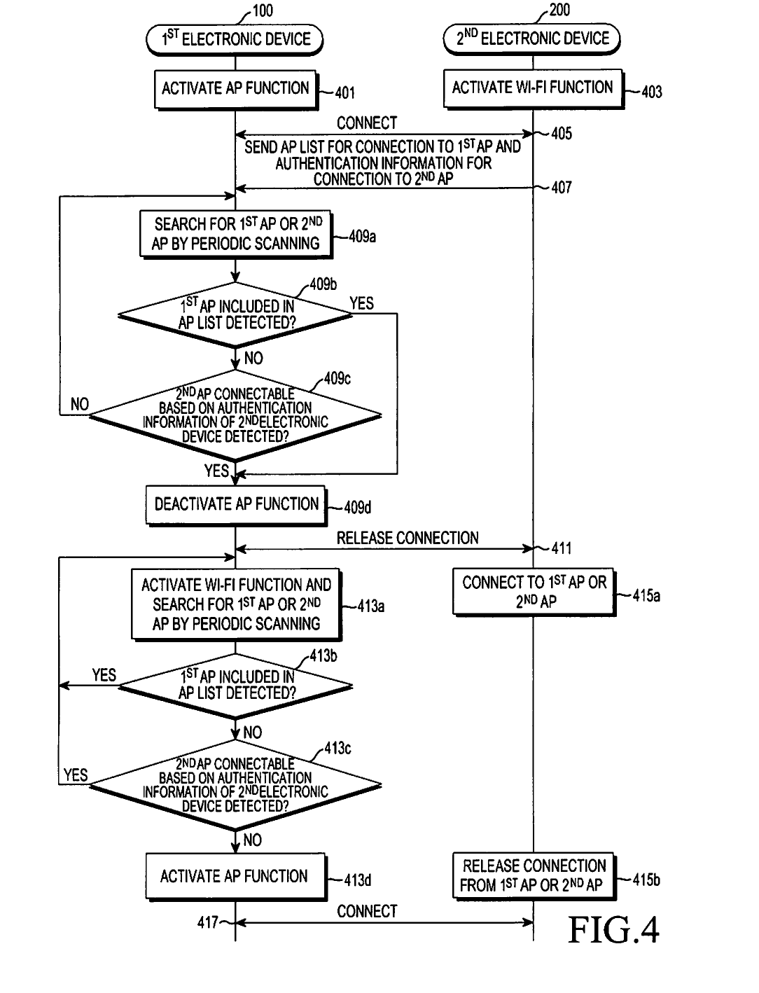

FIG. 4 is a flowchart illustrating an operation for providing a data service in an electronic device according to another embodiment of the present invention. The embodiment of the present invention will be described in detail with reference to FIGS. 1 and 4.

Referring to FIG. 4, if the user turns on tethering in the first electronic device 100, the controller of the first electronic device 100 (i.e., the first controller) activates the AP function so that the first electronic device 100 may serve as a Wi-Fi AP in step 401.

Before or after the activation of the AP function in the first electronic device 100, if the user turns on the short-range wireless communication function, for example, the Wi-Fi function, and thus the W-FI function is activated in the second electronic device 200, the controller of the second electronic device 200 (i.e., the second controller) detects the first electronic device 100 with the AP function activated by scanning and displays the first electronic device 100 as a connectable first AP on the display of the second electronic device 200 in step 403.

If the user of the second electronic device 200 selects the first electronic device 100 as a first AP and enters, for example, a password for authentication, the first and second electronic devices 100 and 200 connect to each other in step 405.

Once the second electronic device 200 is connected to the first electronic device 100, the second controller transmits, to the first electronic device 100, an AP list including information about at least one first AP that has been connected before to the second electronic device 200, and authentication information for automatic connection of the second electronic device 200 to a second AP operating in a different connection scheme from the first AP, stored in the second electronic device 200, in step 407. Then the second controller may use a data service provided by the connected first electronic device 100.

Alternatively, after the first and second electronic devices 100 and 200 are connected to each other, the first controller may transmit identification information indicating the first electronic device 100, for example, a phone number, to the second electronic device 200. When the second controller determines that the connected AP is the first electronic device 100 based on the identification information received from the first electronic device 100, the second controller transmits the AP list and the authentication information to the first electronic device 100.

In another embodiment of the present invention, the AP list and the authentication information may be transmitted to the first electronic device 100 by a WLAN action frame or a data frame.

In step 409a, upon receipt of the AP list from the second electronic device 200, the first controller searches for at least one nearby first AP included in the AP list or a nearby second AP connectable to the second electronic device 200 based on the authentication information by periodic background scanning.

Upon detection of a first AP included in the AP list by the scanning in step 409b, the first controller deactivates the AP function in step 409d, and thus releases the connection from the second electronic device 200 in step 411.

If it is detected that the first AP is not included in the AP list in step 409b, the first controller detects whether a second AP is connectable to the second electronic device 200 in step 409c. Upon detection of the second AP connectable to the second electronic device 200 based on the authentication information in step 409c, the first controller deactivates the AP function in step 409d, and thus releases the connection from the second electronic device 200 in step 411. If it is not detected that the second AP is connectable to the second electronic device 200 in step 409c, the first controller returns to step 409a.

If the first controller detects at least one of a first AP and a second AP in operations 409b and 409c, the first controller deactivates the AP function of the first electronic device 100.

A condition for deactivating the AP function in operation 409b or 409c may be set. For example, if the position of the first electronic device 100 is not changed and a first AP included in the AP list or a second AP connectable to the second electronic device 200 based on the authentication information of the second electronic device 200 is detected a predetermined number of times or more (e.g., three or more times) for a predetermined time period, the AP function may be deactivated. Alternatively, if the position of the first electronic device 100 is changed and a first AP included in the AP list or a second AP connectable to the second electronic device 200 based on the authentication information of the second electronic device 200 is detected a predetermined number of times or more (e.g., three or more times) for a predetermined time period, the AP function may be deactivated.

After the connection release from the second electronic device 200, the first controller performs periodic scanning by activating the short-range wireless communication function, for example, the Wi-Fi function, and thus keeps searching for a nearby first AP included in the AP list or a nearby second AP connectable to the second electronic device 200 based on the authentication information of the second electronic device 200 in step 413a.

If the first controller fails to detect a first AP included in the AP list by the periodic scanning in step 413b, the first controller activates the AP function in operation 413d. If the first AP is detected in step 413b or the second AP is detected in step 413c, the first controller returns to step 413a.

Or if the first controller fails to detect a second AP connectable to the second electronic device 200 based on the authentication information of the second electronic device 200 in operation 413c, and if the first controller fails to detect a second AP connectable to the second electronic device 200 based on authentication information by periodic background scanning in step 413c, the first controller activates the AP function of the first electronic device 100 in step 413d.

If the second controller discovers a first AP included in the AP list or a second AP connectable to the second electronic device 200 based on the authentication information of the second electronic device 200 by scanning after the connection release from the first electronic device 100, the second controller automatically connects the second electronic device 200 to the detected first AP or second AP in step 415a. If the connection is released from the first AP or the second AP during the data service in progress from the first AP or the second AP in step 415b, the second controller automatically connects the second electronic device 200 to the first electronic device 100 with the AP function activated by scanning in step 417. Since the first electronic device 100 is included as a first AP in the AP list of the second electronic device 200, if the second electronic device 200 detects the first electronic device 100 by scanning, the second electronic device 200 may be connected automatically to the first electronic device 100.

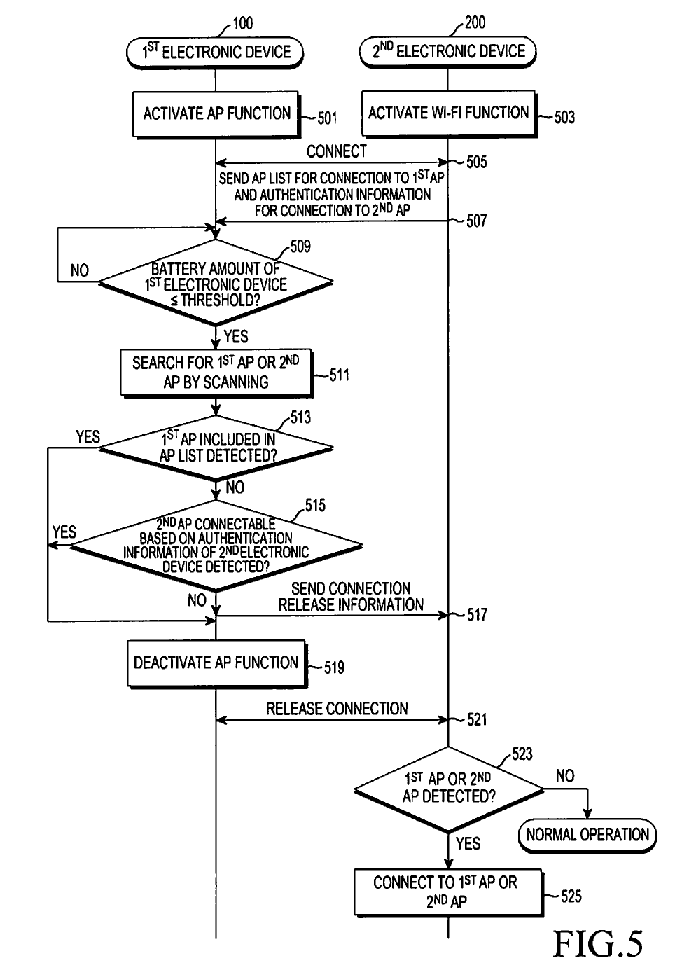

FIG. 5 is a flowchart illustrating an operation for providing a data service in an electronic device according to another embodiment of the present invention. The embodiment of the present invention will be described in detail with reference to FIGS. 1 and 5.

Referring to FIG. 5, if the user turns on tethering in the first electronic device 100, the controller of the first electronic device 100 (i.e., the first controller) activates the AP function so that the first electronic device 100 serves as a Wi-Fi AP in step 501.

Before or after the activation of the AP function in the first electronic device 100, if the user turns on the short-range wireless communication function, for example, the Wi-Fi function, and thus the W-FI function is activated in the second electronic device 200, the controller of the second electronic device 200 (i.e., the second controller) detects the first electronic device 100 with the AP function activated and displays the first electronic device 100 as a connectable first AP on the display of the second electronic device 200 in step 503.

If the user of the second electronic device 200 selects the first electronic device 100 as a first AP and enters, for example, a password for authentication, the first and second electronic devices 100 and 200 connect to each other in step 505.

Once the second electronic device 200 is connected to the first electronic device 100, the second controller transmits, to the first electronic device 100, an AP list including information about at least one first AP that has been connected before to the second electronic device 200, and authentication information for automatic connection of the second electronic device 200 to a second AP operating in a different connection scheme from the first AP, stored in the second electronic device in step 507. Then the second controller may use a data service provided by the connected first electronic device 100.

Alternatively, after the first and second electronic devices 100 and 200 are connected to each other, the first controller may transmit identification information indicating the first electronic device 100, for example, a phone number, to the second electronic device 200. When the second controller determines that the connected AP is the first electronic device 100 based on the identification information received from the first electronic device 100, the second controller transmits the AP list and the authentication information to the first electronic device 100. In another embodiment of the present invention, the AP list and the authentication information may be transmitted to the first electronic device 100 by a WLAN action frame or a data frame.

In step 509, while the first electronic device 100 is connected to the second electronic device 200, the first controller compares a battery amount of the first electronic device 100 with a predetermined threshold.

If the battery amount of the first electronic device 100 is less than or equal to the threshold in step 509, the first controller performs scanning in step 511. The first controller searches for at least one first AP included in the AP list or a second AP connectable to the second electronic device 200 based on the authentication information of the second electronic device 200 in step 511.

If the first controller fails to detect a first AP included in the AP list by the scanning in step 513 and a second AP connectable to the second electronic device 200 based on the authentication information of the second electronic device 200 in step 515, the first controller transmits information indicating connection release caused by battery shortage to the second electronic device 200 in step 517. Upon receipt of the information indicating connection release caused by battery shortage from the first electronic device 100, the second controller may display a message that the connection will be released due to battery shortage on the display of the second electronic device 200.

After transmitting the information indicating connection release caused by battery shortage to the second electronic device 200 in step 517, the first controller deactivates the AP function in step 519, and thus releases the connection from the second electronic device 200 in step 521.

On the other hand, if the first controller detects a first AP included in the AP list in step 513 or a second AP connectable to the second electronic device 200 based on the authentication information of the second electronic device 200 by the scanning in step 515, the first controller deactivates the AP function in step 519, and thus releases the connection from the second electronic device 200 in step 521.

After the connection release from the first electronic device 100, the second controller may search for a nearby first AP included in the AP list or a nearby second AP connectable based on the authentication information of the second electronic device 200 by scanning in step 523. If the second controller detects a first AP or a second AP by the scanning, the second controller automatically connects the second electronic device 200 to the detected first or second AP. If not, the second controller performs a normal operation.

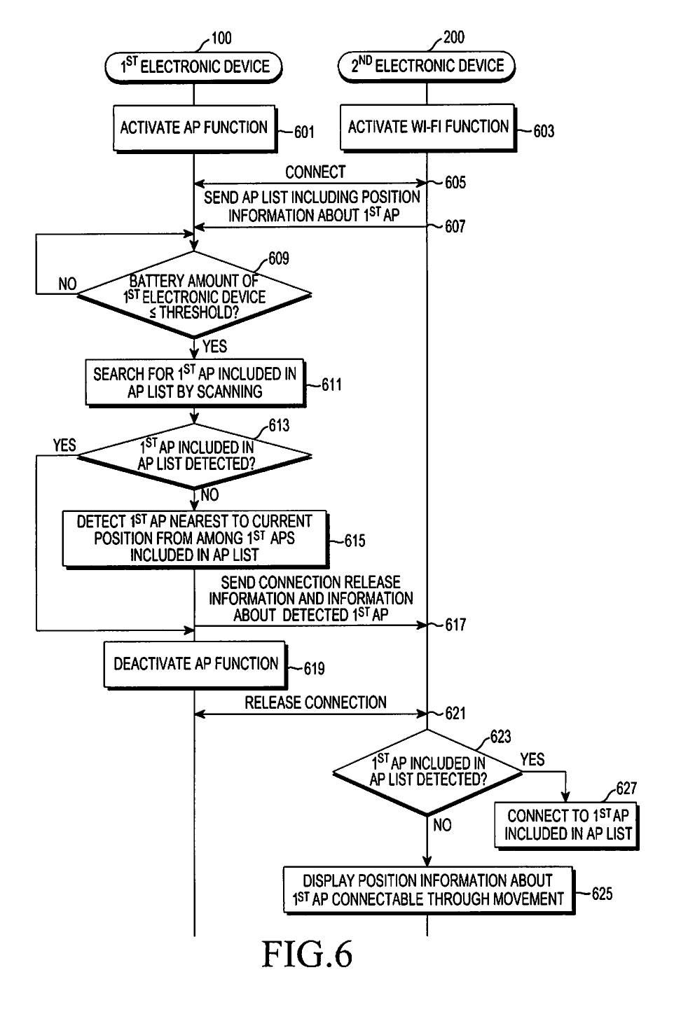

FIG. 6 is a flowchart illustrating an operation for providing a data service in an electronic device according to another embodiment of the present invention. The embodiment of the present invention will be described in detail with reference to FIGS. 1 and 6.

Referring to FIG. 6, if the user turns on tethering in the first electronic device 100, the controller of the first electronic device 100 (i.e., the first controller) activates the AP function so that the first electronic device 100 serves as a Wi-Fi AP in step 601.

Before or after the activation of the AP function in the first electronic device 100, if the user turns on the short-range wireless communication function, for example, the Wi-Fi function, and thus the W-FI function is activated in the second electronic device 200, the controller of the second electronic device 200 (i.e., the second controller) detects the first electronic device 100 with the AP function activated by scanning and displays the first electronic device 100 as a connectable first AP on the display of the second electronic device 200 in step 603.

If the user of the second electronic device 200 selects the first electronic device 100 as a first AP and enters, for example, a password for authentication, the first and second electronic devices 100 and 200 connect to each other in step 605.

Once the second electronic device 200 is connected to the first electronic device 100, the second controller transmits, to the first electronic device 100, an AP list including information about at least one first AP that has been connected before to the second electronic device 200 and position information about the at least one first AP, stored in the second electronic device in step 607. When the second controller stores information about a first AP connected to the second electronic device 200 in the AP list, the second controller may also store position information about the first AP. Then the second controller may use a data service provided by the connected first electronic device 100.

Alternatively, after the first and second electronic devices 100 and 200 are connected to each other, the first controller may transmit identification information indicating the first electronic device 100, for example, a phone number, to the second electronic device 200. When the second controller determines that the connected AP is the first electronic device 100 based on the identification information received from the first electronic device 100, the second controller transmits the AP list to the first electronic device 100. In another embodiment of the present invention, the AP list may be transmitted to the first electronic device 100 by a WLAN action frame or a data frame.

In step 609, while the first electronic device 100 is connected to the second electronic device 200, the first controller compares a battery amount of the first electronic device 100 with a predetermined threshold.

If the battery amount of the first electronic device 100 is less than or equal to the threshold, the first controller searches for at least one nearby first AP included in the AP list in step 611.

If the first controller fails to detect a first AP included in the AP list by the scanning in step 613, the first controller detects a first AP nearest to a current position of the first electronic device 100 from among the at least one first AP included in the AP list in step 615. Then the first controller transmits information indicating connection release caused by battery shortage along with information about the detected first AP to the second electronic device 200 in step 617.

Upon receipt of the information indicating connection release caused by battery shortage along with the information about the detected first AP from the first electronic device 100, the second controller may display a message that the connection will be released due to battery shortage on the display of the second electronic device 200.

After transmitting the information indicating connection release caused by battery shortage along with the information about the detected first AP to the second electronic device 200, the first controller deactivates the AP function in step 619, and thus releases the connection from the second electronic device 200 in step 621.

On the other hand, if the first controller detects a first AP included in the AP list by the scanning in step 613, the first controller deactivates the AP function in step 619, and thus releases the connection from the second electronic device 200 in step 621.

After the connection release from the first electronic device 100, the second controller searches for a first AP included in the AP list by scanning in step 623. If the second controller fails to detect a first AP included in the AP list by the scanning, the second controller detects position information about the first AP indicated by the first electronic device 100 in the AP list stored in the second electronic device 200 and displays the position information on the display of the second electronic device 200 in step 625. The second controller may display a message indicating the position information about the first AP connectable by movement on the display of the second electronic device 200 in step 625.

On the other hand, if the second controller detects a first AP included in the AP list by the scanning in step 623, the second controller automatically connects the second electronic device 200 to the detected first AP in step 627.

The electronic device and method for providing a data service in the electronic device of the present invention may be implemented as computer-readable code in a computer-readable recording medium. The computer-readable recording medium may include any kind of recording device storing computer-readable data. Examples of the recording medium may include Read Only Memory (ROM), Random Access Memory (RAM), optical disk, magnetic tape, floppy disk, hard disk, non-volatile memory, and the like, and may also include the medium that is implemented in the form of carrier waves (for example, transmission over the Internet). In addition, the computer-readable recording medium may be distributed over the computer systems connected over the network, and computer-readable codes may be stored and executed in a distributed manner.

As is apparent from the foregoing description, an electronic device and a method for providing a data service in the electronic device according to various embodiments of the present invention provides a data service, while reducing current consumption of the electronic device.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An electronic device comprising:
a short-range wireless communication unit configured to provide a short-range wireless communication function; and
a controller configured, if the electronic device is connected to another electronic device upon activation of an Access Point (AP) function, to detect an AP connectable to the other electronic device, and if an AP connectable to the other electronic device is detected, to deactivate the AP function.

2. The electronic device of claim 1, wherein, if the electronic device is connected to the other electronic device upon activation of the AP function, the controller receives at least one of an AP list and authentication information from the other electronic device, the AP list including information about at least one first AP that has been connected before to the other electronic device, and the authentication information being used for automatic connection of the other electronic device to a second AP operating in a different connection scheme from a first AP.

3. The electronic device of claim 1, wherein, if the electronic device is connected to the other electronic device upon activation of the AP function, the controller transmits, to the other electronic device, identification information indicating that the other electronic device is connected to the electronic device, and receives at least one of an AP list and authentication information from the other electronic device, the AP list including information about at least one first AP that has been connected before to the other electronic device, and the authentication information being used for automatic connection of the other electronic device to a second AP operating in a different connection scheme from a first AP.

4. The electronic device of claim 1, wherein, if the AP function is deactivated, the controller performs scanning by activating the short-range wireless communication function, searches for an AP connectable to the other electronic device by the scanning, and if the AP connectable to the other electronic device is not detected, activates the AP function.

5. The electronic device of claim 1, wherein, the controller,
if the electronic device is connected to the other electronic device upon activation of the AP function, receives, from the other electronic device, an AP list including information about at least one first AP that has been connected before to the other electronic device;
if a first AP included in the AP list is detected by scanning, deactivates the AP function;
if the AP function is deactivated, performs scanning by activating the short-range wireless communication function;
searches for a first AP included in the AP list by the scanning; and
if the first AP included in the AP list is not detected, activates the AP function.

6. The electronic device of claim 1, wherein, the controller,
if the electronic device is connected to the other electronic device upon activation of the AP function, receives, from the other electronic device, an AP list including information about at least one first AP that has been connected before to the other electronic device; and
if a battery amount of the electronic device is less than or equal to a threshold while the electronic device is connected to the other electronic device, searches for a first AP included in the AP list by scanning.

7. The electronic device of claim 6, wherein, if the first AP included in the AP list is detected, the controller deactivates the AP function, and if the first AP included in the AP list is not detected, the controller transmits connection release information to the other electronic device and deactivates the AP function.

8. The electronic device of claim 1, wherein, the controller,
if the electronic device is connected to the other electronic device upon activation of the AP function, receives an AP list and authentication information from the other electronic device, the AP list including information about at least one first AP that has been connected before to the other electronic device, and the authentication information being used for automatic connection of the other electronic device to a second AP operating in a different connection scheme from a first AP; and
if a first AP included in the AP list or a second AP connectable to the other electronic device based on the authentication information is detected, deactivates the AP function.

9. The electronic device of claim 8, wherein, the controller,
if the AP function is deactivated, performs scanning by activating the short-range wireless communication function;
searches for a first AP included in the AP list or a second AP connectable to the other electronic device based on the authentication information by the scanning; and
if the first AP included in the AP list or the second AP connectable to the other electronic device based on the authentication information is not detected, activates the AP function.

10. The electronic device of claim 1, wherein, the controller,
if the electronic device is connected to the other electronic device upon activation of the AP function, receives an AP list and authentication information from the other electronic device, the AP list including information about at least one first AP that has been connected before to the other electronic device, and the authentication information being used for automatic connection of the other electronic device to a second AP operating in a different connection scheme from a first AP; and
if a battery amount of the electronic device is less than or equal to a threshold while the electronic device is connected to the other electronic device, searches for a first AP included in the AP list or a second AP connectable to the other electronic device based on the authentication information by scanning; and
if the first AP included in the AP list or the second AP connectable to the other electronic device based on the authentication information is detected, deactivates the AP function.

11. The electronic device of claim 10, wherein, if the first AP included in the AP list or the second AP connectable to the other electronic device based on the authentication information is not detected, the controller transmits connection release information to the other electronic device and deactivates the AP function.

12. The electronic device of claim 1, wherein, the controller,
if the electronic device is connected to the other electronic device upon activation of the AP function, receives from the other electronic device an AP list including information about at least one first AP that has been connected before to the other electronic device, and position information about the at least one first AP;
if a battery amount of the electronic device is less than equal to a threshold while the electronic device is connected to the other electronic device, searches for a first AP included in the AP list by scanning; and
if the first AP included in the AP list is not detected, transmits connection release information along with information about a first AP nearest to a current position of the electronic device from among the at least one first AP included in the AP list to the other electronic device, and deactivates the AP function.

13. A method for providing a data service in an electronic device, the method comprising:
if the electronic device is connected to another electronic device upon activation of an Access Point (AP) function, detecting an AP connectable to the other electronic device by scanning; and
if an AP connectable to the other electronic device is detected, deactivating the AP function.

14. The method of claim 13, further comprising, if the electronic device is connected to the other electronic device upon activation of the AP function, receiving at least one of an AP list and authentication information from the other electronic device, the AP list including information about at least one first AP that has been connected before to the other electronic device, and the authentication information being used for automatic connection of the other electronic device to a second AP operating in a different connection scheme from a first AP.

15. The method of claim 13, further comprising, if the electronic device is connected to the other electronic device upon activation of the AP function, transmitting, to the other electronic device, identification information indicating that the other electronic device is connected to the electronic device, and receiving at least one of an AP list and authentication information from the other electronic device, the AP list including information about at least one first AP that has been connected before to the other electronic device, and the authentication information being used for automatic connection of the other electronic device to a second AP operating in a different connection scheme from a first AP.

16. The method of claim 13, further comprising, if the AP function is deactivated, performing scanning by activating a short-range wireless communication function, searching for an AP connectable to the other electronic device by the scanning, and if the AP connectable to the other electronic device is not detected, activating the AP function.

17. The method of claim 13, further comprising:
if the electronic device is connected to the other electronic device upon activation of the AP function, receiving, from the other electronic device, an AP list including information about at least one first AP that has been connected before to the other electronic device;
if a first AP included in the AP list is detected by scanning, deactivating the AP function;
if the AP function is deactivated, performing scanning by activating a short-range wireless communication function;
searching for a first AP included in the AP list by the scanning; and
if the first AP included in the AP list is not detected, activating the AP function.

18. The method of claim 13, further comprising:
if the electronic device is connected to the other electronic device upon activation of the AP function, receiving, from the other electronic device, an AP list including information about at least one first AP that has been connected before to the other electronic device; and
if a battery amount of the electronic device is less than or equal to a threshold while the electronic device is connected to the other electronic device, searching for a first AP included in the AP list by scanning.

19. The method of claim 18, further comprising:
if the first AP included in the AP list is detected, releasing the connection from the other electronic device by deactivating the AP function; and
if the first AP included in the AP list is not detected, transmitting connection release information to the other electronic device and releasing the connection from the other electronic device by deactivating the AP function.

20. The method of claim 13, further comprising:
if the electronic device is connected to the other electronic device upon activation of the AP function, receiving an AP list and authentication information from the other electronic device, the AP list including information about at least one first AP that has been connected before to the other electronic device, and the authentication information being used for automatic connection of the other electronic device to a second AP operating in a different connection scheme from a first AP; and
if a first AP included in the AP list or a second AP connectable to the other electronic device based on the authentication information is detected, deactivating the AP function.

21. The method of claim 20, further comprising:
if the AP function is deactivated, performing scanning by activating a short-range wireless communication function;
searching for a first AP included in the AP list or a second AP connectable to the other electronic device based on the authentication information by the scanning; and
if the first AP included in the AP list or the second AP connectable to the other electronic device based on the authentication information is not detected, activating the AP function.

22. The method of claim 13, further comprising:
if the electronic device is connected to the other electronic device upon activation of the AP function, receiving an AP list and authentication information from the other electronic device, the AP list including information about at least one first AP that has been connected before to the other electronic device, and the authentication information being used for automatic connection of the other electronic device to a second AP operating in a different connection scheme from a first AP; and
if a battery amount of the electronic device is less than or equal to a threshold while the electronic device is connected to the other electronic device, searching for a first AP included in the AP list or a second AP connectable to the other electronic device based on the authentication information by scanning; and
if the first AP included in the AP list or the second AP connectable to the other electronic device based on the authentication information is detected, deactivating the AP function.

23. The method of claim 22, further comprising, if a first AP included in the AP list or a second AP connectable to the other electronic device based on the authentication information is not detected, transmitting connection release information to the other electronic device, and deactivating the AP function.

24. The method of claim 13, further comprising:
if the electronic device is connected to the other electronic device upon activation of the AP function, receiving from the other electronic device an AP list including information about at least one first AP that has been connected before to the other electronic device, and position information about the at least one first AP;
if a battery amount of the electronic device is less than or equal to a threshold while the electronic device is connected to the other electronic device, searching for a first AP included in the AP list by scanning; and
if the first AP included in the AP list is not detected, transmitting connection release information along with information about a first AP nearest to a current position of the electronic device from among the at least one first AP included in the AP list to the other electronic device and deactivating the AP function.
